(19) United States
(12) Patent Application Publication
(10) Pub. No.: US 2012/0048255 A1
(43) Pub. Date: Mar. 1, 2012

(54) WIRE SAW

(76) Inventors: Daniel Fricker, Steffisburg (CH); Christoph Gurtner, Steffisburg (CH); Roberto Povegliano, Moosseedorf (CH)

(21) Appl. No.: 13/318,176

(22) PCT Filed: May 3, 2010
(86) PCT No.: PCT/EP10/55962

§ 371 Date: Oct. 31, 2011

(30) Foreign Application Priority Data
May 4, 2009 (EP) 09159312.9

(51) Int. Cl. B28D 5/04; B23P 6/00

(52) U.S. Cl. 125/16.02; 29/402.08

(57) ABSTRACT

In a wire saw that serves for cutting polygonal, columnar bricks out of an ingot of a generally inorganic crystalline material, more particularly a semiconductor material, a cutting yoke (5) having at least two angularly offset saw wire fields is provided that is displaceable in the saw feed direction (7). The yoke is coupled to a carrier (38) by means of an assembly of two rails (40, 42). In this manner, the yoke (5) is easily removable from the process chamber (1) of the wire saw by pulling one rail (42) out of the other rail (40) in order to perform maintenance operations etc. The saw wire in the cutting yoke (5) is guided in an essentially meander-shaped path so that the cutting wire essentially only extends in the wire fields (sections 14, 16) and on the sides of the frame (20) of the cutting yoke (5).

The present invention relates to a wire saw according to the preambles of claim 1 or 8.

To divide a (semiconductor) ingot or generally a body of an inorganic crystalline material into so-called bricks, wire saws are used, inter alia. Generally speaking, the latter offer the advantage of low material losses. In a general manner, bricks are columns having a polygonal cross-section, mostly a square or rectangular cross-section. However, e.g. a hexagonal cross-section is also possible. A wire saw for this application has two or more wire fields that are arranged one after another in the cutting direction and are angularly offset from one another. For a rectangular cross-section of the bricks, the angle is equal to 90°.

Wire saws of this kind are e.g. known in the art from JP-A-3049863 and EP-A-0 734 824. One problem in these wire saws is that of accessing the wire guides and wire deflection devices for maintenance purposes. Likewise it is complicated to thread the saw wire into the wire fields. As compared to wafer wire saws, accessing the wire guides is more difficult due to the more complex wire path.

In addition, after a sawing operation, all parts in the sawing area, particularly also the deflection rollers etc., are covered with a significant layer of the working fluid that contains the abrasive as well as abrasive dust, i.e. the so-called slurry.

Another problem is that a spiral-shaped wire path as depicted in JP-A-3049863 requires relatively great wire lengths. The ingot is moved through the saw wire fields and is subsequently, in the divided condition, enclosed between the saw wire field and the other circumferential wire saw sections, i.e. within the saw wire spiral. Consequently, a correspondingly large cross-section of the latter is required.

It is therefore a first object of the present invention to provide a wire saw in which the access to the wire fields is simplified.

Another object is to provide a wire saw having an improved wire path, more particularly with wire fields having shorter non-cutting sections of the saw wire.

Such wire saws are defined in claims 1 and 8. The further claims indicate preferred embodiments and a method using the wire saw.

According to the first aspect, the cutting yoke with the saw wire fields is fastened to the wire saw by means of a releasable retaining device. The retaining device is designed such that the cutting yoke can be removed from the wire saw in a simple manner. The retaining device preferably consists of a rail assembly to which the cutting yoke, which cuts through a workpiece from the top to the bottom, is suspended. More specifically, the parts of the rail assembly are mutually displaceable so that the yoke can be moved out of the machine.

In the inserted condition, the rail assembly is preferably lockable, e.g. by means of a clamping device, so that the cutting yoke is immovably retained in its working position.

According to the second aspect, the wires run through the sawing zone to the edge of the cutting yoke and are deflected there 180° essentially. Thus, in the simplest arrangement, a meander-shaped path of the saw wire results. However, it is not excluded that the saw wire is deflected at greater intervals such that the wire first runs e.g. through lines 1, 3, 5 of a wire field and later, possibly after running through the other wire field, through the lines of the wire field that were first omitted.

In a preferred embodiment, the saw wire is first deflected 90° out of the cutting plane, e.g. by deflection rollers. The result is essentially that the 180° turns of the meander are folded up perpendicularly to the cutting plane and in parallel to the saw feed direction, respectively. By this arrangement it is achieved that the load resulting from the pressure of the saw wires applied to the workpiece acts upon the former deflection devices perpendicularly to the deflection axis, which extends in the cutting plane. In contrast thereto, a 180° deflection roller whose axis extends in the feed direction, i.e. horizontally, would be loaded in the direction of its axis of rotation, i.e. the flanks of its running groove would be subject to greater wear.

The invention shall be further explained by means of an exemplary embodiment and with reference to the Figures.

They show:

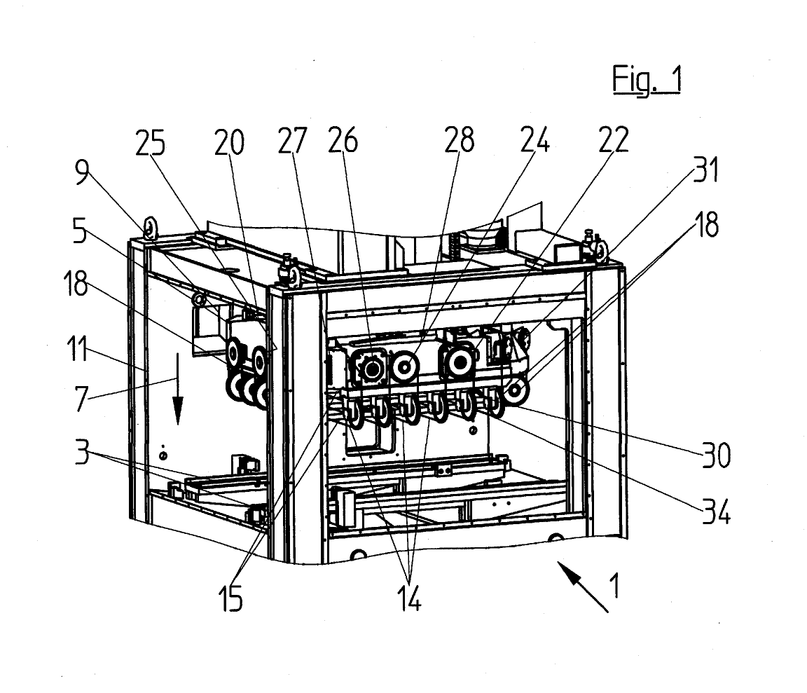

FIG. 1 view of a process chamber of a wire saw;

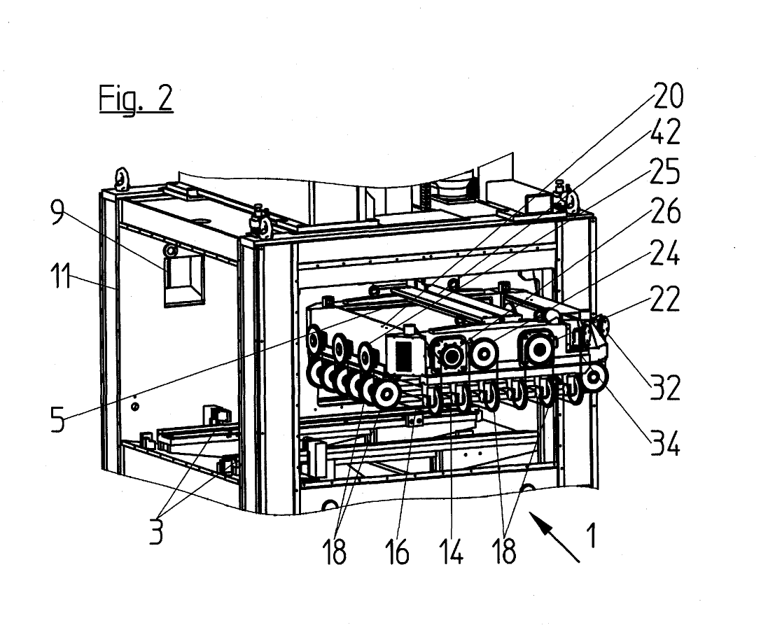

FIG. 2 same view as in FIG. 1, cutting yoke pulled out;

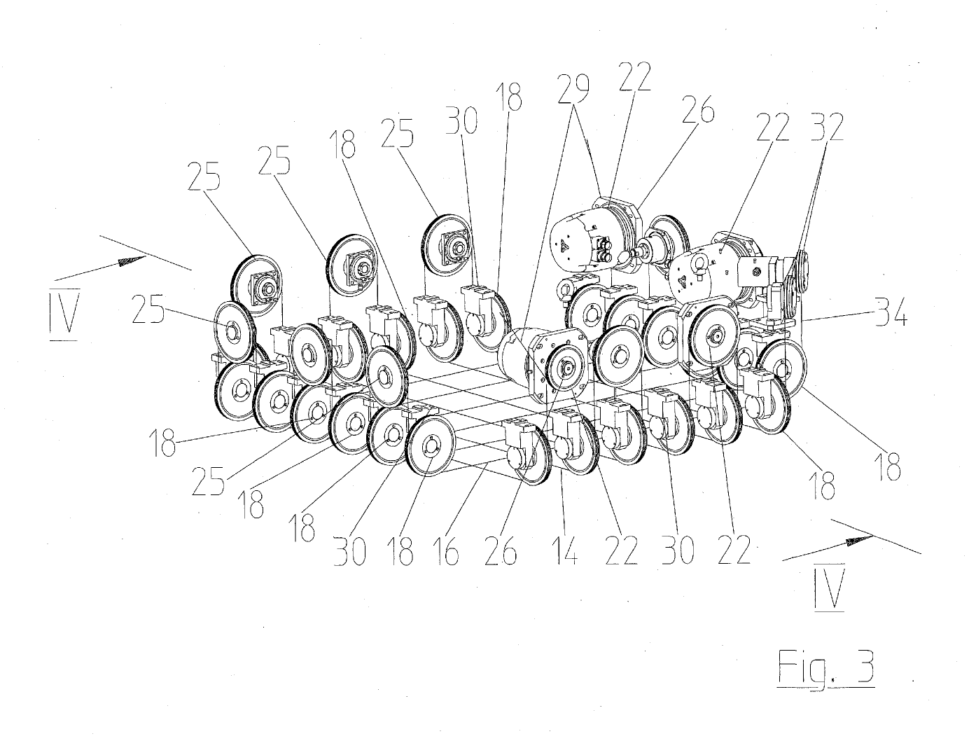

FIG. 3 schematic diagram of wire path in cutting yoke;

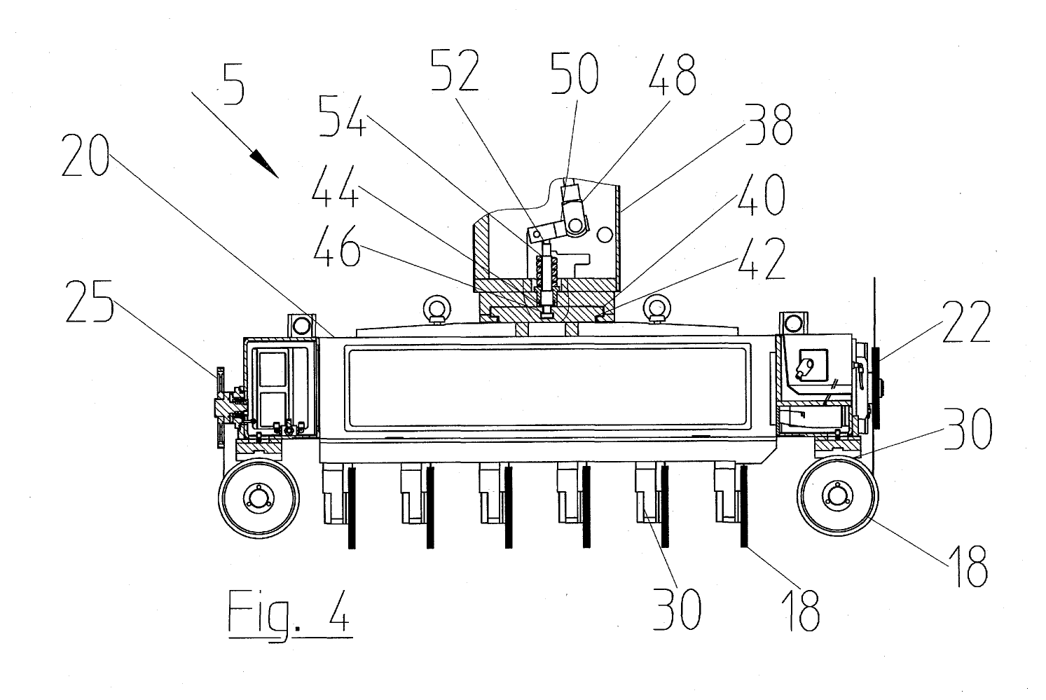

FIG. 4 sectional view of cutting yoke and retaining device according to sectional line IV-IV in FIG. 3.

FIG. 1 shows the process chamber 1 of a wire saw. At the rear of process chamber 1, the remaining parts of such a wire saw are located as they are known in the art and therefore not depicted. More particularly, these include further guiding devices and the reels for the saw wire, slurry supply units etc. At the bottom of process chamber 1, support 3 for the workpiece carrier is arranged. The workpiece is supported thereon while cutting yoke 5 descends from above (arrow 7) in order to cut the bricks out of the ingot, i.e. the workpiece. The saw wire is supplied to cutting yoke 5 through a window 9 in rear wall 11 and guided out of process chamber 1 through a second window that is not visible here. In the sawing operation, the saw wire is moved a certain length in one direction and then back a somewhat shorter distance. All in all, the result is a slow forward motion. Alternatively, the wire may be moved in one direction entirely and then back.

At the bottom of cutting yoke 5, the saw wire sections 14 of the first wire field are arranged and perpendicularly thereto, saw wire sections 16 of the second field. The saw wire is deflected in parallel to feed direction 7 by means of deflection rollers 18 arranged on the lower side of frame 20 of cutting yoke 5. Then it runs over 180° return rollers 22, 24, and 25, with two exceptions. One of the exceptions is the first one of these return rollers 26: By this roller 26, the wire guided from the supply section of the wire saw into process chamber 1 is guided via a roller assembly arranged near the left forward corner 27 (in FIG. 1) of yoke 5 onto return roller 26 in parallel to front beam 28 of cutting yoke 5. Since this roller assembly (not shown), which is designed according to the prior art, is arranged in the process chamber in a stationary manner, the saw wire always runs onto roller 26 and off the latter tangentially, depending on the direction of motion of the cutting wire, however under a variable angle that is a function of the height of cutting yoke 5 in the process chamber. Approximately, the contact arc on roller 26 would be 220° in the represented upper position and nearly 360° in the lowermost position near the end of the sawing operation.

A corresponding situation and construction is found at the diagonally opposite corner of cutting yoke 5 where the other end of the saw wire is guided out of process chamber 1. For more clarity, FIG. 3 shows the arrangement of the rollers essentially without the stationary parts of yoke 5. Here, yoke 5 is in a lower position near the end of an operating sequence, and the entering and exiting saw wire 29 runs off rollers 26 upwardly, the contact arc thereon being approximately 320°.

Deflection rollers 18 define the division of the two wire fields. In the present case, each wire field has six parallel wire sections (lines) 14, 16 so that 25 bricks can be sawed out of each ingot in one sawing cycle. Here, the outermost wires cut off the slab of the ingot. Deflection rollers 18 are rotatively supported in bearing blocks 30 individually.

The fact that the rollers, more particularly rollers 18, are supported individually also offers the advantage that an uneven wear of the rollers, i.e. different diameters thereof, has no influence upon the wire tension. Smaller deflection rollers, possibly also as a result of manufacturing tolerances, may rotate faster than larger ones.

Driving return rollers 22, 26 are provided with a motor drive whereas the two return rollers 24 therebetween are provided with a load measurement device. Also provided with a load measurement device is one of diagonal deflection rollers 32. Diagonal deflection rollers 32 guide saw wire 34 from the first saw wire field to the second saw wire field extending perpendicularly thereto. The signals of the load measurement devices serve for continuously detecting the tension of saw wire 34 and controlling the drives of return rollers 22, 26 in such a manner that a constant mean wire tension results in the wire fields overall. However, due to the friction of the saw wire on the ingot, it is unavoidable that the wire tension increases in the wire feed direction between one return roller 22, 26 and the respective next one.

Return rollers 25 opposite rollers 22, 24, and 26 are free-wheeling.

Altogether, in the present example, a drive is provided after every fourth line, and the saw wire tension is likewise measured after every fourth line at an interval of two lines.

As appears particularly in FIGS. 2 and 4, yoke 5 is suspended to a carrier 38. Carrier 38 is displaceable in the saw feed direction (arrow 7). The connection between carrier 38 and cutting yoke 5 is formed by a rail assembly of two rails 40, 42 on carrier 38 and on cutting yoke 5, respectively. Rail 40 encloses rail 42 on both sides. Centrally in rail 42, an undercut groove 44 extends in which clamping anchors 46 engage. As shown in FIG. 2, by inserting rail 42 into rail 40 while clamping anchors 46 are lowered, yoke 5 can be pushed into process chamber 1 up to a predetermined position. In the simplest case, this position is determined by rail 42 abutting at the rear end of rail 40. Yoke 5 is locked in this position by an upward movement of bar 48 which presses rear end 52 of clamping anchor 46 down via lever 50. This movement can be achieved in any desired manner, e.g. motor-driven, hydraulically or pneumatically.

As a result, clamping anchor 46 is pushed upwards by spring 54 and rail 42 is thereby locked.

By the inverse procedure, which starts with pushing down bar 48 in order to release rail 42, yoke 5 can be removed from the process chamber. Further transport may be achieved by a usual mobile or stationary transport device that connects to the sides of yoke 5 or is e.g. engaged in loops at the forward or rearward beam of yoke 5. When removed from process chamber 1, cutting yoke 5 is easily serviceable since return rollers 22, 24, 26 and diagonal deflection rollers 32 are now freely accessible laterally or from below. Likewise it is easily possible to exchange cutting yoke 5 for another cutting yoke e.g. having a different division, i.e. wire fields having a different number of wire sections, or an overhauled yoke.

Furthermore, the insertion of a threading wire or cable is possible in a comfortable manner outside process chamber 1.

Then, after the insertion of cutting yoke 5 into process chamber 1, the ends of this threading wire are connected to the ends of the actual saw wire and the latter is threaded into cutting yoke 5 by pulling out the threading wire.

Another advantage of the described process chamber 1 is that the ingots can be supplied and removed laterally, more particularly by moving them through the chamber. In contrast thereto, the removal and the introduction of the yoke are achieved frontally, thereby avoiding any interference of the respective transport devices.

Also, within frame 22 of yoke 5, the supply lines for the operating fluids (slurry, compressed air, etc.) and other connections (measurement and control connections, etc.) are arranged in a manner known to one skilled in the art. In a usual manner, the saw wire is a steel wire of approx. 0.25 mm in diameter.

From the foregoing description, modifications and improvements of the device according to the invention are accessible to one skilled in the art without departing from the scope of protection of the invention which is defined by the claims. Conceivable are e.g.:
Choice of the number of clamping anchors 46 according to the design of rails 40, 42, e.g. 8.
Support and manufacture of the deflection rollers from different materials and with different surfaces, e.g. steel rollers with an replaceable running surface of polyurethane.
A different number of wire fields, e.g. 3 that are angularly offset 60° from one another, in this case e.g. in a hexagonal cutting yoke, to obtain bricks having a hexagonal cross-section.
A different number of lines in the fields with a lower limit of two lines, in order only to cut off the slab in the extreme case. At least three lines in at least one field are preferred.
Use of the signals of the load measurement devices on the deflection rollers for controlling the feed during the sawing operation.
A different ratio of the lines of the yoke to the driving and load measuring rollers is chosen, which may include the rollers 25 that are free-wheeling in the example. A design rule results from the fact that the tension of the wire is minimum after each driving roller and maximum before the respective rollers. The difference is the result of the friction of the wire in the cutting gap in the ingot and is also a function of the feed speed, among others. The minimum wire tension may not be lower than a certain value for a straight, uniform cut, the maximum is determined by the breaking stress.
Instead of a saw wire to which slurry is applied, a wire-shaped sawing medium with embedded abrasive material is used, e.g. a diamond saw wire.
Use of saw wire of up to 0.5 mm in diameter or even up to 1 mm in diameter.

1. Wire saw for dividing inorganic crystalline bodies into a plurality of columnar pieces having an essentially polygonal cross-section in a feed direction, the wire saw having at least two wire fields with at least two lines of saw wire each, and the lines of a wire field being arranged in the field at least so as not to overlap and preferably essentially parallelly, wherein the wire fields are arranged in a yoke, the saw wire guiding devices are arranged in a frame of the yoke, in that the yoke is coupled to the wire saw by means of a releasable retaining device, and in that the retaining device is arranged so as to insert or remove the yoke through a movement that is at least partly transversal to the feed direction.

2. Wire saw according to claim 1, wherein the retaining device is connected to a transport device by which the retaining device is movable in the feed direction.

3. Wire saw according to claim 1, wherein the saw wire lines within a field are arranged in parallel essentially.

4. Wire saw according to claim 1, wherein in the feed direction, the yoke has a lower section on the bottom side and opposed thereto an upper side, the saw wire fields are located in the lower section essentially, and the retaining device is located on the upper side essentially.

5. Wire saw according to claim 1, wherein the yoke has an essentially even-numbered polygonal and preferably rectangular cross-section and the retaining device extends in parallel to two parallel and opposed sides of the yoke essentially, so that the yoke can be supported or suspended at the opposed sides during its insertion or removal.

6. Wire saw according to claim 1, wherein the retaining device is essentially an assembly of rails sliding in each other that are mutually displaceable transversally to the feed direction and preferably mutually extendable, one rail being fastened to the yoke and the other rail to a mount of the wire saw.

7. Method for the maintenance or the changeover of a wire saw according to claim 1, wherein the yoke is removed by releasing the retaining device and by a movement transversally to the feed direction, the yoke being placed on a transport means or suspended to a transport means.

8. Wire saw for dividing inorganic crystalline bodies into a plurality of columnar pieces having an essentially polygonal cross-section in a feed direction, preferably according to claim 1, the wire saw having at least two wire fields with at least two lines of saw wire each, and the lines of a wire field being arranged within the respective field at least so as not to overlap and preferably essentially parallelly, wherein the path of the saw wire within a wire field is essentially meander-shaped with two respective, not necessarily adjacent lines of a wire field except the beginning and the end of the wire field being connected by a meander loop, the wire fields are arranged in a yoke, the meander loops of the saw wire are deflected in a direction parallel to the feed direction by first deflection means, and return roller means are arranged in the meander turns in order to guide the saw wire.

9. Wire saw according to claim 8, wherein at least one return roller means is provided with a drive in order to move the saw wire forward.

10. Wire saw according to claim 9, wherein at least the first and the last return roller means are provided with a drive such that the saw wire is movable forward and backward.

11. Wire saw according to claim 9, wherein before each return roller means that is provided with a drive, a return roller means is provided with a load measurement device so that the wire tension can be measured and maintained at a defined value or within a predetermined range by controlling the drive of the driven return roller means that follows in the wire feed direction.

12. Wire saw according to claim 8, wherein the saw wire is guided from one wire field to the other wire field by a deflection device, a load measurement device for measuring the saw wire tension being optionally provided in the deflection device.

13. Wire saw according to claim 8, wherein the deflection means are deflection rollers that are rotatively supported independently of each other.

14. (canceled)

15. Wire saw according to claim 1, wherein the diameter of the saw wire is one millimeter at most, preferably 0.5 millimeter at most.

16. Wire saw according to claim 8, wherein the diameter of the saw wire is one millimeter at most, preferably 0.5 millimeter at most.
